(19) United States
(12) Patent Application Publication
(10) Pub. No.: US 2016/0357890 A1
(43) Pub. Date: Dec. 8, 2016

(54) Verification Log Analysis

(71) Applicant: Vtool Ltd., Benei Brak (IL)

(72) Inventors: Hagai Arbel, Tel Aviv (IL); Uri Feigin, Tel Aviv (IL); Ilan Kleinberger, Tel Aviv (IL); Anna Ravitzki, Paris (FR)

(21) Appl. No.: 15/172,381

(22) Filed: Jun. 3, 2016

Related U.S. Application Data
(60) Provisional application No. 62/170,777, filed on Jun. 4, 2015.

(51) Int. Cl. G06F 17/50; G06F 11/36

(52) U.S. Cl. CPC G06F 17/5009; G06F 11/3652; G06F 17/5045; G06F 11/3696

(57) ABSTRACT

A verification log analyzer graphically represents a log file generated from a simulation. The log analyzer depicts the log file visually and/or graphically, for example, in the form of a bar graph or timeline. The bar graph can include one axis (e.g., the x-axis) that represents the time of the simulation, with various events/messages displayed as graphics along the timeline. The timeline can include a series of bars, boxes, icons, images, or other identifiers that represent messages from the verification log. The log analyzer can expand, collapse, zoom in, and zoom out on the graphical log file. The log analyzer can also add, remove, or restrict information provided by the graphical log file.

### RELATED APPLICATIONS

This application claims priority to U.S. provisional patent application No. 62/170,777, filed Jun. 4, 2015, titled “Verification Log Analysis,” which is hereby incorporated by reference in its entirety.

### TECHNICAL FIELD

The present disclosure generally relates to design verification testing. More specifically, the present disclosure generally relates to the analysis, processing, and/or debugging of verification log files generated from any hardware simulation tool.

### BACKGROUND

Proper integrated circuit design must consider several factors that relate to electronics, circuits, analog functions, logic, and other functionality. For example, before an integrated circuit is released for production, an integrated circuit device may undergo a series of simulation tests to ensure that it will operate as planned and expected. These simulation tests are referred to as design verification.

Conducting simulations will typically generate two primary types of outputs: log files, and simulation signals state database (also referred to as “waves”).

Log files often include textual messages generated by one or more parts of the verification environment. For example, log files may generate information and/or messages relating to an event, an error, or other similar operation that occurred during the simulation.

Signals, or waves, include nodes of the register transfer level and their state (e.g., represented by a “0” or a “1”) throughout the simulation. These signals can be maintained in a database that can later be read into the simulator waveform viewer. This can facilitate inspection of the RTL nodes to determine the RTL node value at a specific time during the simulation.

As with virtually all computer software, verification simulators will encounter program errors or “bugs” that can create issues in the operation of the software. Thus, applying debugging techniques on the simulation software can be helpful to reduce, limit, inhibit, prevent, or otherwise eliminate bugs from the RTL design and the verification code (verification environment). Debugging can also be used to find bugs in the verification environment and related code.

Typically, a user performs debugging techniques on a simulation results by reading the messages in the log file and cross-referencing those messages with the signals in the signal database. But this process can be very slow, time consuming, labor intensive, and subject to further error, as it requires the user to process a large amount of data, and to navigate back and forth through countless events and pieces of data.

### SUMMARY

The present disclosure describes a log analyzer that graphically and/or visually represents a log file that is generated from a simulation, and related methods. In some examples, the log analyzer depicts the log file graphically in the form of a bar graph or timeline. One axis (e.g., the x-axis) of an exemplary bar graph/timeline will represent the time throughout the simulation, while various events, messages, or other recorded pieces of information are displayed as graphics along the timeline. For example, the timeline can include a series of bars, boxes, icons, images, notifications, or other identifiers that represent messages from the verification log. Each graphic can symbolically reference the log file message, or can otherwise be accessed by a user interface to display information pertaining to the log file message. In some examples, the log analyzer can manipulate the view and display of the bar chart/timeline, for example, by enabling expand, collapse, zoom in, and/or zoom features of the graphical log file. Some examples of the log analyzer provide the ability to add, remove, or restrict information provided by the graphical log file. And in some embodiments, the log analyzer allows a user to search, filter, sort, or otherwise organize information in the log file (which can contain a significantly large amount of information) to facilitate the processing of information in the log file.

In some aspects, the log analyzer generates a video representation of the log file. This is particularly suitable where the simulation is performed on a verification environment that is built graphically. In this manner, the video log file can graphically demonstrate the simulation of the verification by depicting the operation of the graphics, modules, and devices represented in the graphical environment at each step of the simulation.

In other aspects, the log analyzer can generate visual images that represent the verification log file. For example, the log analyzer can generate a 2d image where each pixel of the image represents an event or a time period during the simulation. Based on the color or other features of the pixel, the image can portray useful information about the log file to a viewer.

### BRIEF DESCRIPTION OF THE DRAWINGS

FIG. 1 is a block diagram showing an interface operating a verification log analyzer tool in accordance with embodiments described herein.

FIGS. 2-3 show examples of an interface operating a verification log analyzer tool in accordance with embodiments described herein.

### DETAILED DESCRIPTION

The present disclosure describes examples and embodiments of a verification tool analyzer and/or debugger. The present disclosure will make reference to various terms, phrases, and abbreviations relating to test simulations run on integrated circuit designs. For reference, several of those terms are described in more detail below.

The phrase “device under test” or (“DUT”) refers to an integrated circuit, or a chip (e.g. a microchip), that is to be tested by the simulation programs described herein.

The phrase “functional verification” refers to a verification technique (e.g., for a DUT) that simulates test scenarios (or test cases) on the DUT.

The phrase “register transfer level” (“RTL”) refers to a representation of the chip logic. RTL can be written in Verilog or System-Verilog or VHDL language. In some aspects, RTL may also be referred to as “the design.”

The phrases “verification environment” or “testbench” refer to code written in a programming language (e.g., C, C++, SystemVerilog, Specman, etc.) that is used to create tests scenarios for the simulation. The verification environment can be used to inject data to the design, to collect the outputs, and compare to expected results, for example.

A “verification tool” refers to a software tool that is used to develop verification environments. The verification environments can represent modules and other objects that may interact with a DUT. The verification tool can generate source code that simulates the operation of the DUT and the verification environment when the source code is executed by a simulator.

A “simulator” refers to a software tool that compiles the verification environment and the RTL to run test scenarios.

The phrases “debug” and “debugging” refer to the processes for analyzing simulation results, in particular failed simulation results, to determine the causes of the failures, and/or to diagnose the failures. In some aspects, debugging can be used to determine whether the failures are due to problems with the RTL (e.g., a design bug) or problems with the testbench.

Certain aspects of the presently disclosed technology can be used with specific verification programs and software. For example, some aspects described herein can be used specifically with the verification tool(s) described in the '636, the '067, and the '183 applications and the '899 provisional, which are incorporated by reference in their entireties. These references describe computers and computer processors that employ a combination of a user interface and a memory, and are configured to execute a series of programs to generate test simulation code that can be executed by a simulator. These particular verification tools include facilitate graphical design verification environments, such that the source code representing the environment can be created and viewed visually in a manner that can be more easily digested by a developer and/or user. The code that the verification tool generates can be scalable and tested with a cross-simulator.

The programs of the verification tool can include, for example, an environment building program that builds a graphical environment for display on a user interface in response to receiving an “add-graphic” input signal. The verification tool can also include a signal connector program that assigns connection signals to verification graphics in the graphical environment in response to receiving an “add-connection” input signal. The verification tool can also include a code generating program that generates test simulation code in response to receiving a generation input signal.

As explained in the aforementioned '636, '067, and '183 applications (and the '899 provisional), the verification tools can also include a number of other programs, sub-programs, or functionality that can facilitate the development of verification environments.

The test simulation code that the verification tool generates can be executed (e.g., by a simulator) to simulate the operation of an integrated circuit device. A memory (e.g., a computer hard drive) can maintain databases and arrays of information that allow a user to build verification environments and establish connections and signals between the various components of these environments.

These particular verification tools can generate graphical environments that represent simulations on the DUT. Graphically generated environments present improvements over other environments represented by lines of text and/or code because humans can recognize, remember, and comprehend graphical representations (e.g., shapes and colors) better than lines of text, code, or data.

Running a simulation of DUT's modeled via the graphically based verification tool will generate log files and one or more signal database as described above. Typically, these log files and signal databases will be represented with text, data, or other information that is complex and difficult for a user to digest and comprehend.

The presently described log analyzer works with the aforementioned verification tools (and can also be configured to operate with other verification tools) to process the text of the file log and present that information in a variety of visual formats that may be easier for users to digest. For example, the log analyzer can create many types of views that are based on visual representations of events. Some examples of the log analyzer also provide a user with an option to apply filters, search terms, and other control and parameters so that only desired information is presented.

In some aspects, the log analyzer is be configured to automatically chose these filters/search terms/controls. For example, the Vtool analyzer may be configured to recognize bugs based on patterns in the log data. In this manner, the log analyzer can identify “hidden bugs” that are showing themselves in a manner that a user would be unlikely to notice.

In some examples, the log analyzer takes advantage of the specific interaction with the aforementioned graphically driven verification tools. Because the log analyzer can be configured to operate with the graphically driven verification tools, the log analyzer knows and understands the format of the code for the verification environment and the resulting log files generated through the simulation. With this information, the log analyzer can be configured to specifically generate visual representations of the log files in a similar format, or a format based in part upon that of the verification tool. It should be noted, however, that the described Vtool analyzer can be configured to operate with various types of verification log files.

The log analyzer can be configured to represent the log files in a variety of different configurations. In some examples, the log analyzer applies graphical representations of the log files.

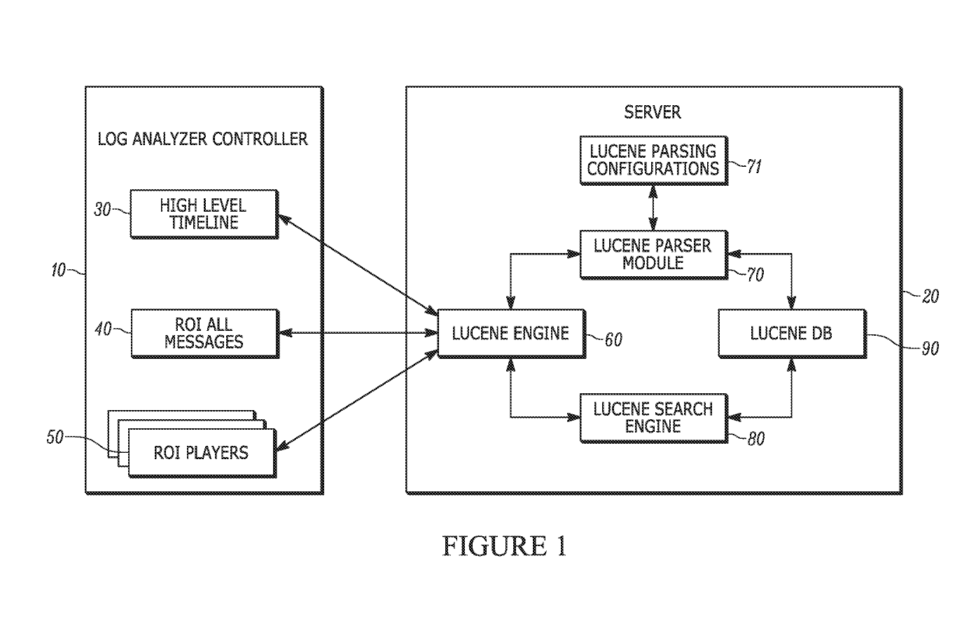

FIG. 1 is a block diagram of the various aspects of the general architecture of the log analyzer controller 10 interfacing with a server 20. The general flow is a follows.

The user sets the log file in the log analyzer controller 10. The log analyzer controller 10 calls the Lucene engine 60, which, in turn, calls the Lucene parser module 70. The parser module 70 reads the parser configuration 71, and saves the result in the Lucene database (DB) 90. The parser module 70 then completes the parsing and returns the completed parsing details to the Lucene engine 60, which returns them to the log analyzer controller 10. The log analyzer controller 10 then tells the high level timeline 30 that parsing is complete.

The high level timeline 30 requests full log mini-map details from the Lucene engine 60, and the Lucene engine 60 then performs the searches against the Lucene DB 90, and returns the results to the Lucene engine 60. The Lucene engine 60 then returns the results to the high level timeline 30 for display.

The log analyzer controller 10 then requests a list of errors from the Lucene engine 60, which passes the requests to the Lucene log searcher 80. The searcher 80 searches the Lucene DB 90 and returns the results to the Lucene engine 60, which will return the results to the log analyzer controller 10. If the request returns a list of errors, the log analyzer controller 10 creates a list of relevant players 50.

The log analyzer controller 10 sets the default ROI region and notifies the ROI all message 40 and all players 50. Each of the players 50 and the ROI all messages 40 query the Lucene engine 60 with their relevant search parameters. The query will be forwarded to the Lucene search engine 80, which will search against the Lucene DB 90, and return the response to the requesting object for display.

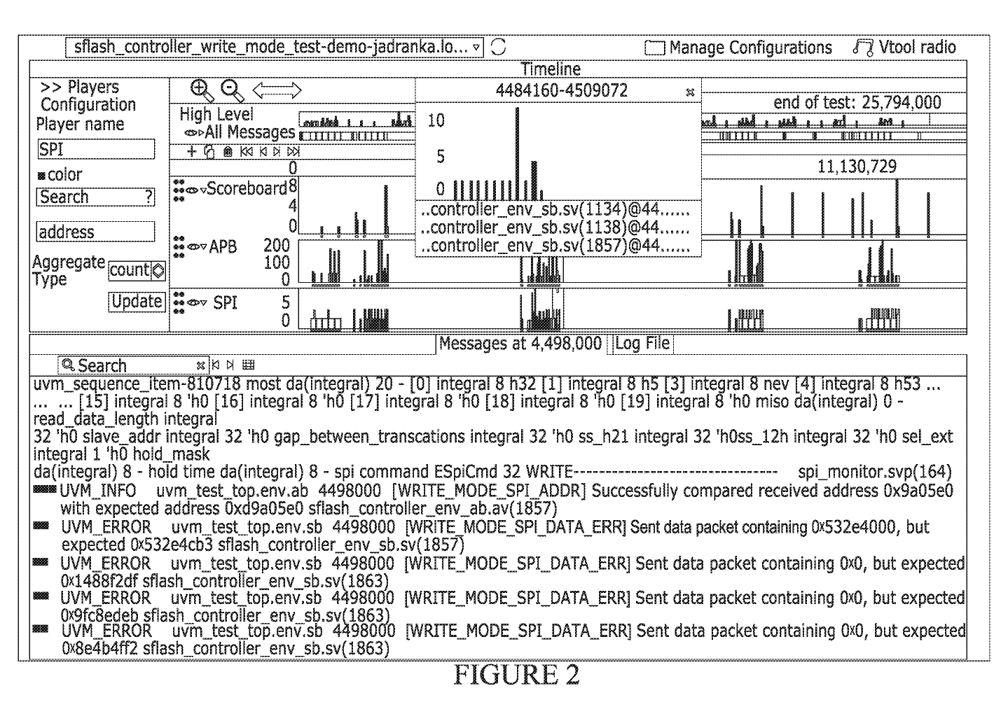

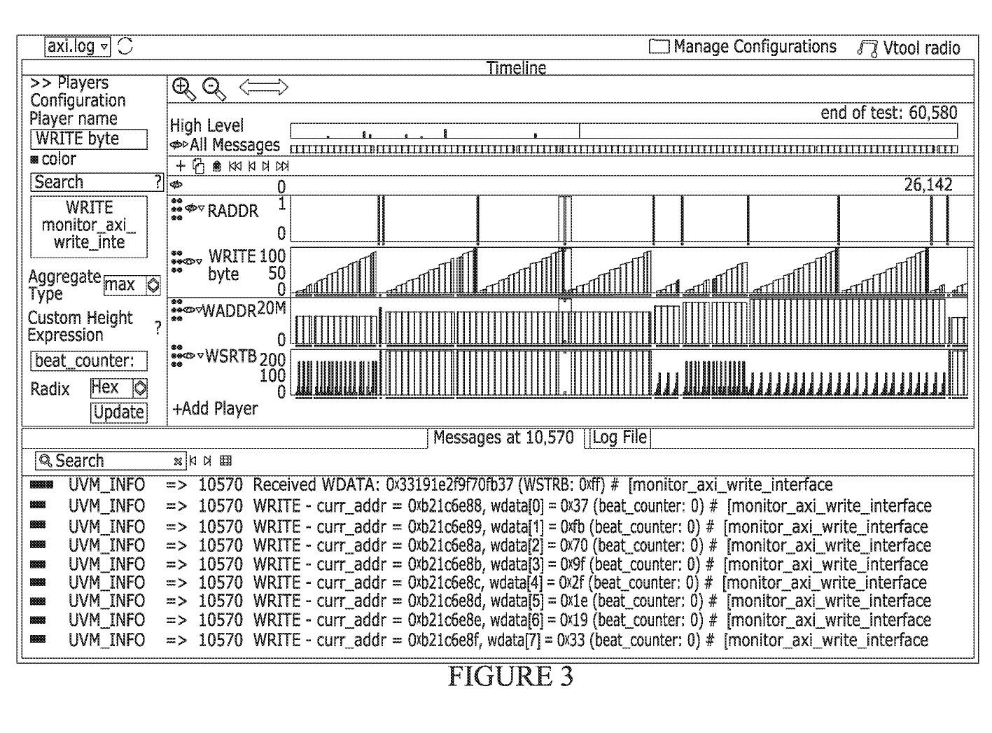

FIGS. 2-3 depict screen shots of an interface implementing examples of the presently described log analyzer. The depicted screen shots show interfaces that operate the log analyzer in connection with the graphical verification tools described above.

The interface in FIGS. 2-3 shows tabs that represent a “create” interface that allows a user to create a verification environment, a “debug” interface that presents access to many and/or all of the log analyzer tools described herein, and a “documentation” interface that presents documentation of the simulation.

In some examples the log analyzer can represent the information as a bar chart. FIGS. 2-3 show various exemplary configurations of an interface depicting graphical representations of log files as a bar chart.

Some examples of the depicted bar charts are zoom-able. That is, the chart can be zoomed in to see log files in more detail (that is, to view log files recorded over a shorter or narrower window of time), or zoomed out to present a higher level depiction of the log files (that is, to view log files recorded over a wider window of time).

In some examples, the log analyzer allows a user to apply filters to the display by the entity that initiated the message to the log file (identified as “emitter”), by text of the message body, or by severity of the message (e.g., error, warning, info, etc.). For example, a user may be able to use the log analyzer to search or sort for only messages of a certain type, or to exclude messages of a certain type, for example.

On the bar charts represented in FIGS. 2-3, the x-axis represents simulation time. That is, the x axis represents the amount of time (represented in nanoseconds) elapsed from the commencement of the simulation. The boxes represent an error message from the log file at the given time. The boxes can be depicted in different colors to represent different types of messages. In some examples, the boxes are stacked into bars, for example, when the messages are initiated on or around the same simulation time slot.

In some examples, the bar chart also depicts messages (or errors, warnings, etc.) in the form of distinguishable icons such as flags, exclamation points, yield or warning signs, or the like.

In some examples, the interface may comprise a lower viewing window positioned beneath the bar chart. This lower window displays information pertaining to the messages represented in the chart. For example, FIGS. 2-3 present examples of the lower window displaying information associated with the messages that are represented in the bar chart. These messages can include, for example, the text or data of the original log file, a summary or explanation of the message, a representation icon visualizing the message category, or a color code to associate the message with a category.

In some examples, the debugging interface can collapse the bar chart. For example, in the collapsed mode, each point in time only shows the emitters rather than a bar or box graphic on a timeline. The number and type of events under each emitter can be represented with colored bars. The emitters can be sorted by severity and/or by number of errors. In some examples, it may be possible to add search/sort/filter controls to a toolbar to allow a user to sort or filter emitters by various features (e.g., alphabetically by emitter name).

In some examples, the interface can be configured so that clicking on an emitter will expand an emitter to show some or all of the events associated therewith. A user may be able to expand or collapse all of the emitters (e.g., via an “expand all” or “collapse all” feature), or individually expand/collapse certain select emitters.

In some examples, certain emitters can be pinned to the top of each timepoint on the bar chart. In this manner, pinned emitters can appear on the interface even where the particular timepoint associated with the pinned emitter is not depicted on the bar chart.

The interface may also utilize an “extra-minimized” view that shows only bars representing severity (or other relevant information) for each emitter. Clicking on a column or event can then expand the information displayed and allow a user to view more information pertaining to the emitter. Such a view can be useful where the emitters would otherwise display an overwhelming amount of information on the interface, or where the information displayed in a normal view would not fit.

In some examples, the bar chart can be zoomable, and can present a “minimap” timeline. The minimap timeline can show a specific portion of the overall timeline in a zoomed in manner (e.g., via the boxed window shown in FIG. 2). In this manner a user can see a high level view of the overall timeline (e.g., in a scrollable manner) and a more detailed “zoomed in” view of one or more selected portions of the timeline. Using this feature, a user may be able to discern patterns quickly (e.g., from a high level), and then quickly jump to the important events (e.g., fatal errors), by zooming in to those portions of the time line.

Some examples of the log analyzer employ other techniques for representing the log files. For example, the log files can be represented as objects video onto a diagram.

An RTL's functionality (i.e., the design) is based on receiving inputs and objects (e.g., communication packets, image files, etc.), processing the inputs and received objects, and then sending or transmitting outputs and objects such as processed communication packets, computation results and control signals to the system, etc. In this situation the verification environment generates these objects, drives the objects to the design, and then collect the output objects.

One representation can be in the form of a verification log video that illustrates the operation of objects generated within the verification environment, sent to the design, collected from the design outputs and checked for their correctness. For example, using the graphical verification tool described above, a computer can generate a test simulation based upon a graphical verification environment that graphically depicts a DUT and other verification modules interacting with the DUT.

In operation, the verification log video can show video images (e.g., in an animated manner), or a series of still images that can be displayed in a frame-by-frame manner. When viewed, these video images through the many blocks of the verification environment, into the design and out for checking. The video can display the operation and functions objects in the environment block diagram, which objects may have been generated, for example, by the graphical verification tools described above. For example, the verification log video can show the graphical verification environment with the DUT and a number of verification graphics, and its operation.

Throughout the simulation, various verification graphics (representing verification modules) will perform certain functions as they interact with the DUT. The verification log video can display these operations, for example, by highlighting each verification graphic as it operates with the DUT. In some examples, the verification log video can generate text or audio to explain the interaction, and/or the errors/messages generated.

A user viewing the verification log video can watch the video as an animated movie that automatically operates continuously, or as a frame-by-frame display of images of the verification environment, browsed through at the discretion and control of the user. The user can control the speed of travel, for example, by clicking a “next” button (e.g., to display the image of the next step), by running a pre-defined footage (e.g., by selecting a simulation from time X to time Y), or by selecting a fast forward feature, a re-wind feature, a pause feature, or the like.

In other examples, the log analyzer will generate an image that presents visual information representing the log file. For example, the log analyzer can use color dots or pixels to create an image. Each pixel of the image is associated with a coordinate (e.g., positions along the x and y axes) and color. In some examples, each pixel can be associated with other features, such as size or shape. Applying a set of rules, a user can use the log analyzer to draw or otherwise generate an image using the associated pixel values (e.g., coordinates and colors).

For example, for each object is pushed to the design, the log analyzer may draw a green pixel starting at the bottom left corner going up. The log analyzer may draw a red pixel on an opposite corner for each object collected at the output. At the end of simulation, the exemplary log analyzer will present a get a red and green image that can be meaningful to a user, as it can represent information about the pushed and collected objects of the simulation. Other aspects may employ different colors, more than two colors, three dimensional images, and other aspects that can visually provide useful information about the log file to a user.

This application builds on the disclosure of U.S. patent application Ser. No. 62/170,777 filed Jun. 4, 2015 (“the '777 application”), Ser. No. 14/565,636 filed Dec. 10, 2014 (“the '636 application”), Ser. No. 14/678,067 filed Apr. 3, 2015 (“the '067 application”), Ser. No. 14/678,138 filed Apr. 3, 2015 (“the '138 application”), and U.S. provisional patent application No. 61/978,899 (“the '899 provisional”), filed Apr. 13, 2014, each of which is incorporated by reference in its entirety herein.

The present disclosure describes preferred embodiments and examples of the present technology. Those skilled in the art will recognize that a wide variety of modifications, alterations, and combinations can be made with respect to the above described embodiments without departing from the scope of the invention as set forth in the claims, and that such modifications, alterations, and combinations are to be viewed as being within the ambit of the inventive concept. All references cited in the present disclosure are hereby incorporated by reference in their entirety.

1) A method of generating a graphical representation of a log file from a simulation for display on a user interface, the method comprising:
generating a verification log file based on a simulated test of a modeled integrated circuit using a computer processor configured to execute test simulation code; and
displaying a graphical model of the verification log file on the user interface, the graphical model comprising at least one bar chart displayed on a user interface that operates in connection with the processor, the bar chart comprising a horizontal axis that represents time elapsed during the simulated test of the modeled integrated circuit and at least one bar along the x-axis, the bar representing a message of the verification log file.

2) The method of claim 1, further comprising displaying via the user interface additional information pertaining to the message in response to receiving an instruction from the user interface.

3) The method of claim 2, wherein the verification log file is generated based on the execution of test simulation code generated by a processor executing a code generating program.

4) A method of generating a graphical representation of a log file from a simulation for display on a user interface, the method comprising:
generating a verification log file based on a simulated test of an integrated circuit using a computer processor configured to execute test simulation code, the test simulation code generated by a code generating program that generates test simulation code from a graphical verification environment model; and
displaying a video image of the verification log file on the user interface, the video image displaying the graphical environment model and the operation of various verification graphics of the graphical environment model during the simulated test of the integrated circuit.

5) A method of simulating testing of an integrated circuit device, the method performed on at least one computer, the method comprising:
on a first computer having a memory, a processor, and a user interface:
displaying a device under test graphic on the user interface as a component of a graphical environment model, the device under test graphic corresponding to source code that executes on a simulator to represent an integrated circuit device;
receiving an add-graphic input signal via the interface;
in response to receiving the add-graphic input signal, displaying at least one verification graphic as an element of a graphical environment model, each verification graphic associated with source code that executes on a simulator to simulate a verification model interacting with the integrated circuit device;
presenting, via the user interface, an array of available connection signals;
receiving an add-connection input signal via the user interface;
in response to receiving the add-connection input signal, assigning, with the processor, at least one connection signal to the verification graphic in the graphical environment model based on the add-connection input signal, each connection signal corresponding to source code that executes on a simulator to represent a connection between the verification model and the integrated circuit device;
receiving a generation input signal via the user interface; and
in response to receiving the generation input signal, generating with the processor a test simulation code based at least in part on the source code associated with the verification graphic and the assigned connection signal in the graphical environment model, the test code simulating the operation of the integrated circuit device upon execution on a simulator;
on either the first computer or a second computer having a processor and a memory:
executing the test simulation code with a simulation program to simulate testing on the integrated circuit device;
generating a signals database on the memory, the signals database comprising at least one signal representing a logical value of at least one element of the integrated circuit device; and
generating a verification log file comprising at least one message, each message associated with a time during the simulated testing, each message generated by the simulation program; and
on either the first computer, the second computer, or a third computer having a processor, a memory, and a user interface:
displaying a graphical model of the verification log file on the user interface, the graphical model comprising at least one axis representing time during the tested simulation, the graphical model further comprising at least one emitter graphic component along the at least one axis,
wherein each emitter graphic represents a message from the verification log file and wherein the user interface is configured to allow a user to adjust display settings of the displayed graphical model of the verification log file.
